(19) United States
(12) Patent Application Publication
(10) Pub. No.: US 2006/0207361 A1
(43) Pub. Date: Sep. 21, 2006

(54) Ball screw

(75) Inventor: Keisuke Kazuno, Shizuoka-ken (JP)

Correspondence Address: HARNESS, DICKEY & PIERCE, P.L.C., P.O. BOX 828, BLOOMFIELD HILLS, MI, 48303, US

(73) Assignee: NTN Corporation

(21) Appl. No.: 11/376,664

(22) Filed: Mar. 15, 2006

(30) Foreign Application Priority Data
Mar. 15, 2005 (JP) 2005-073559

(51) Int. Cl. F16H 27/02; F16H 29/02; F16H 29/20; F16H 3/06

(52) U.S. Cl. 74/89.44

(57) ABSTRACT

A ball screw (1) used under agitated oil lubrication has a screw shaft (2) formed with a helical screw groove (2a) on its outer circumferential surface. A nut (3) is adapted to fit onto the screw shaft (2). The nut (3) has a helical screw groove (3a) on its inner circumferential surface. A plurality of balls (4) is contained in a rolling passage formed between oppositely arranged screw grooves (2a and 3a). A bridge member (5) is adapted to fit into a bridge window (6) formed through a barrel wall of the nut (3). The bridge member (5) has a connecting groove (5a) to enable the balls (4) to bypass the rolling passage to move into a radially outward circumferential passage. A notch is formed in the bridge member (5) to intercommunicate the outer and inner circumferential portions of the nut (3).

### CROSS-REFERENCE TO RELATED APPLICATIONS

This application claims priority to Japanese Patent Application No. 2005-073559, filed Mar. 15, 2005, which application is herein expressly incorporated by reference.

### FIELD

The present disclosure relates to a ball screw used in vehicle electric-powered actuators or the like, and more particularly, to a ball screw used under agitated oil lubrication.

### BACKGROUND

The ball screws include a screw shaft with a helical ball rolling groove formed on its outer circumferential surface. A nut is adapted to fit onto the screw shaft. The nut is formed with a helical screw groove on its inner circumferential surface. A large number of balls are contained in a rolling passage formed by the oppositely arranged screw grooves. A circulating mechanism is used to enable balls to bypass the rolling passage to move into a radially outward circumferential passage. The ball screw is used as a motion converting mechanism to convert a rotational motion of the nut to a linear motion of the screw shaft.

In general, there are several kinds of ball screws with different ball circulating mechanisms, one of which is a bridge type. In a bridge type ball screw, the nut fits with a bridge member which has a connecting passage to enable balls to bypass from their rolling passage on the screw shaft to a radially outward circumferential passage (the connecting passage formed in the bridge member). This bridge type ball screw is advantageous due to its relatively simple and compact structure.

One representative example of a bridge type ball screw is shown in FIG. 3. Here, the ball screw 50 includes a screw shaft 51 with a helical screw groove 51a on its outer circumferential surface. A nut 52 is adapted to fit onto on the screw shaft 51. The nut 52 has a helical screw groove 52a on its inner circumferential surface. A large number of balls 53 are contained in a rolling passage formed by oppositely arranged screw grooves 51a and 52a. A bridge member (not shown) has a connecting groove to connect mutually adjacent rolling grooves 52a of the nut 52 by one round. In this conventional ball screw, the nut 52 is formed on its cylindrical wall with two oil introducing apertures 54 which communicate with the inside of the nut 52 in an axially spaced manner. An oil introducing portion of each aperture 54 is countersunk to enable oil to be easily introduced. Oil introduced into the inside of the nut 52, through the apertures 54, is discharged at ends of the nut 52 though a gap between the nut 52 and the screw shaft 51.

Due to the oil introducing apertures 54 in communication with a space between the screw grooves 51a and 52a, it is possible to supply sufficient oil into the nut 52. However, if the ball screw is used under agitated oil lubrication conditions, it is liable to lack oil inside the nut 52 due to its short stroke of motion (see Japanese Laid-open Patent Publication No. 108477/2004).

However, in this type of conventional ball screw 50, it increases manufacturing costs of the ball screw 50 to specially form the oil introducing apertures 54. In addition, lack of oil is caused when a flange, for transmitting driving force to any driven element, is provided on one end of the nut 52. The flange blocks oil circulation within the ball screw 50. In such a case, it is necessary to provide oil discharging apertures opposite to the oil introducing apertures (not shown) to smoothly circulate oil through the nut 52. However, this would further increase the manufacturing cost of the ball screw.

### SUMMARY

It is an object of the present disclosure to provide a ball screw which can sufficiently circulate oil within a nut to improve the life of the ball screw without an increase of manufacturing costs.

According to the present disclosure, a ball screw used under agitated oil lubrication conditions comprises a screw shaft formed with a helical screw groove on its outer circumferential surface. A nut is adapted to fit onto the screw shaft. The nut has a helical screw groove on its inner circumferential surface. A plurality of balls is contained in a rolling passage formed between the oppositely arranged screw grooves. A bridge member is adapted to fit into a bridge window formed through a barrel wall of the nut. The bridge member has a connecting groove to enable the balls to bypass the rolling passage and move into a radially outward circumferential passage. A notch is formed in the bridge member to intercommunicate the outer and inner circumferential portions of the nut.

According to the ball screw nut of the present disclosure, since the notch is formed in the bridge member to intercommunicate the outer and inner circumferential portions of the nut, it is unnecessary to specially provide any oil introducing aperture in the nut, as in a conventional manner. In addition, it is possible to circulate oil into the nut without resistance and without providing any oil discharging aperture, even though the ball screw is used in an application where one open end of the nut is blocked.

According to the present disclosure, the bridge member is integrally formed with an arm and guide walls. The arm engages the screw groove of the nut to position the bridge member relative to the nut. The guide walls are adapted to be caulked to side edges of the bridge window. Thus, it is possible to firmly secure the bridge member into the bridge window and prohibit the bridge member from radially outwardly falling out of the bridge window.

According to the present disclosure, the bridge member is made of sintered alloy formed by MIM. Thus, it is possible to easily and exactly form the bridge member into a desired configuration with desired dimension even though it requires high work difficulty and has a complicated configuration.

According to the present disclosure, the guide wall of the bridge member is plastically deformable and has a toughness to ensure strength of the caulked portion. The surface of the connecting groove is hardened, by heat treatment, to at least 30 HRC or more. The connecting groove, where a large stress is generated, has a sufficient resistance to impression and wear. Thus, the guide wall has a desirable toughness. Also, it is possible to prevent the generation of cracks into the nut when the bridge member is fitted into it. Accordingly, it is possible to provide a bridge type ball screw with a bridge member which exhibits properties, such as strength resistance and toughness, which are contrary to each other.

Preferably, the bridge member is made of carburized steel. Its surface is hardened by a carburizing hardening treatment. The surface hardness of the guide wall. is set in a range of about 15˜23 HRC, by annealing. This makes it possible to ensure strength in the caulked portion and to prevent a generation of cracks during caulking.

According to the ball screw of the present disclosure, a screw shaft has a helical screw groove on its outer circumferential surface. A nut is adapted to fit onto the screw shaft. The nut has a helical screw groove on its inner circumferential surface. A plurality of balls is contained in a rolling passage formed between oppositely arranged screw grooves. A bridge member is adapted to fit into a bridge window formed through a barrel wall of the nut. The bridge member has a connecting groove which enables the balls to bypass the rolling passage and move into a radially outward circumferential passage. A notch is formed in the bridge member to intercommunicate the outer and inner circumferential portions of the nut. Accordingly, it is unnecessary to specially provide any oil introducing apertures in the nut as in a conventional manner. In addition, it is possible to circulate oil without resistance and without providing any oil discharging apertures even though the ball screw is used in applications where one open end of the nut is blocked.

A ball screw used under agitated oil lubrication conditions comprises a screw shaft with a helical screw groove on its outer circumferential surface. A nut is adapted to fit onto the screw shaft. The nut has a helical screw groove on its inner circumferential surface. A plurality of balls is contained in a rolling passage formed between oppositely arranged screw grooves. A bridge member is adapted to fit in a bridge window formed through a barrel wall of the nut. The bridge member has a connecting groove to enable balls to bypass the rolling passage and move into a radially outward circumferential passage. The bridge member is made of sintered alloy formed by MIM. The bridge member is integrally formed with an arm engaging the screw groove of the nut to position the bridge member relative to the nut. Also, the bridge member includes guide walls adapted to be caulked to side edges of the bridge window. A notch is formed in the bridge member to intercommunicate the outer and inner circumferential portions of the nut.

Further areas of applicability will become apparent from the description provided herein. It should be understood that the description and specific examples are intended for purposes of illustration only and are not intended to limit the scope of the present disclosure.

### DRAWINGS

Additional advantages and features of the present disclosure will become apparent from the subsequent description and the appended claims, taken in conjunction with the accompanying drawings, wherein:

FIG. 1(a) is a plan view of an embodiment of the ball screw of the present disclosure.

FIG. 1(b) is a longitudinal section view of a ball screw of FIG. 1(a).

FIG. 2(a) is a longitudinal section view of a nut of the present disclosure.

FIG. 2(b) is a partial broken end view of FIG. 2(a).

FIG. 3 is a longitudinal section view of a ball screw of the prior art.

### DETAILED DESCRIPTION

Embodiments of the present disclosure will be described with reference to accompanying drawings.

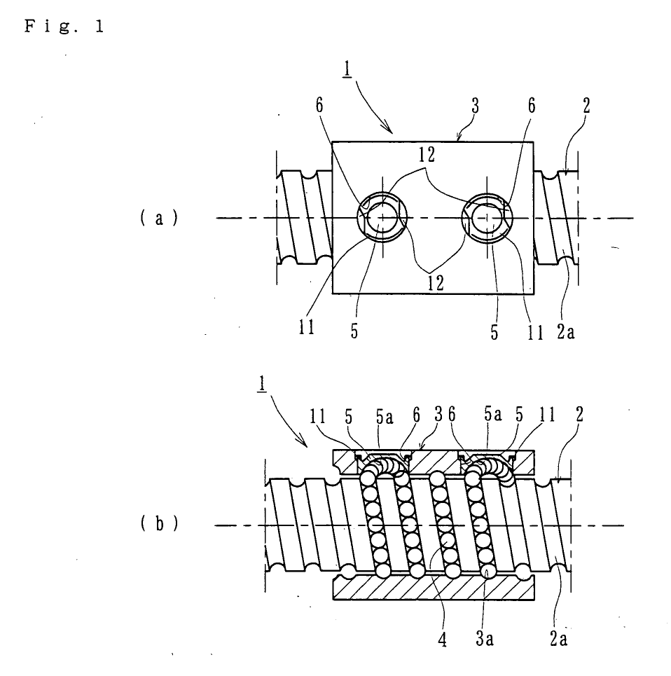

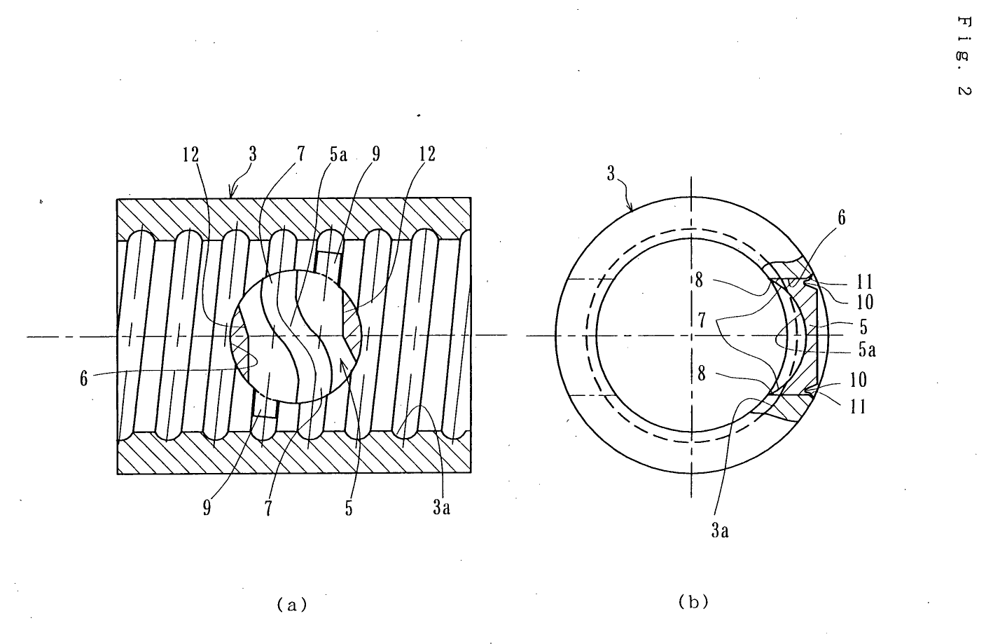

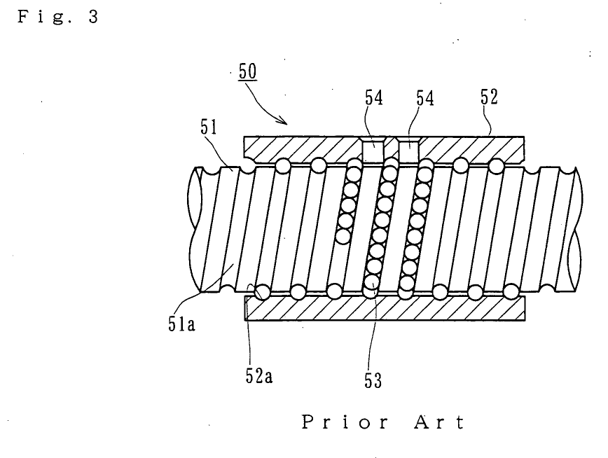

FIG. 1(a) is a plan view of one embodiment of the ball screw of the present disclosure. FIG. 1(b) is a longitudinal section view of the ball screw of FIG. 1(a). FIG. 2(a) is a longitudinal section view of a nut of the present disclosure. FIG. 2(b) is a partial broken end view of FIG. 2(a).

The ball screw 1 includes a screw shaft 2 formed with a helical screw groove 2a on its outer circumferential surface. A nut 3 is adapted to fit onto the screw shaft 2. The nut 3 has a helical screw groove 3a on its inner circumferential surface. A large number of balls 4 are contained in a rolling passage formed between oppositely arranged screw grooves 2a and 3a. A bridge member 5 has a connecting groove 5a to connect mutually adjacent rolling grooves 3a of the nut 3 by one round.

The longitudinal section configuration of each of the screw grooves 2a and 3a may be of a circular or Gothic arc configuration. In this embodiment the Gothic arc configuration is adopted. This configuration ensures a large contacting angle with the ball 4 and a small axial gap. This makes it possible to increase rigidity resistance against an axial load and to suppress vibration of the ball screw.

A circular bridge window 6, where the circular bridge member 5 is fitted, is formed in a barrel of the cylindrical nut 3. The bridge member 5 passes through the wall of the barrel and cuts a portion of the screw groove 3a. A connecting groove 5a, for connecting mutually adjacent rolling grooves 3a of the nut 3 by one round, is formed in the bridge member 5. This connecting groove 5a and a substantially one round portion of the screw groove 3a forms a rolling passage for the balls 4. A large number of balls 4, contained between the inner and outer screw grooves 2a and 3a which form the rolling passage, roll along the screw grooves 2a and 3a. When the balls are guided into the connecting groove 5a of the bridge member 5, the balls 4 climb over the ridge of the screw shaft 1. The balls 4 return into the adjacent screw groove 3a and continue to roll along the screw grooves 2a and 3a.

The connecting groove 5a of the bridge member 5 has a “S” configuration as shown in FIG. 2(a). This smoothly connects the adjacent screw grooves 3a of the nut 3. Accordingly, the connecting groove 5a is adapted to be connected to the screw groove 3a so that opposite opened edges 7 of the connecting groove 5a correspond to opened edges 8 of the screw groove 3a as shown in FIG. 2(b). The depth of the connecting groove 5a is set so that the balls 4 can climb over the ridge of the screw groove 2a of the screw shaft 1 within the connecting groove 5a.

The bridge member 5 is formed with arms 9 each having a substantially semi-cylindrical configuration at either end of the bridge member 5 as shown in FIG. 2(a). Each arm 9 is adapted to engage the screw groove 3a of the nut 3 via a predetermined radial gap in order to axially position the bridge member 5 relative to the nut 3 and to prevent the bridge member 5 from radially outwardly falling out of the bridge window 6. In addition, as shown in FIG. 2(b), the bridge member 5 is formed with recesses 10 on its radial outward surface at circumferentially opposite edges of the bridge member 5. Thus, a pair of guide walls 11 radially extends from the recesses 10. The bridge member 5 can be secured to the nut 3 by caulking the guide walls 11 to the edges of the bridge window 6.

After having mounted the bridge member 5 in the bridge window 6 from radially inside of the nut 3, the incorporation of the balls 4 is carried out by applying the nut 3 to the end of the screw shaft 1. The balls 4 are introduced one by one into the space between the screw grooves 2a and 3a while rotating the nut 3 to move it along the screw shaft 1. The balls 4 can be also introduced into the rolling passage by using a temporary shaft.

The bridge member 5 is made by injection molding a sintered alloy obtained by plastically refining metallic powder. For preparation of the injection molding, first, plastic and a binder, comprised of wax, are mixed and then granulated into pellets from the mixed material. The granulated pellets are fed into a hopper of an injection molding machine. The pellets are heated and injected into a mold under a melted condition to form the sintered alloy by the so-called “MIM” (Metal Injection Molding) process. The sintered alloy formed by MIM can be easily and exactly formed into the dimensioned bridge member of a desired configuration, even though the bridge member requires high work difficulty and has a complicated configuration.

One example of a metallic powder used in this embodiment is a carburizing harden material such as precipitation hardening stainless steel SUS 630 comprising C (0.13 wt %), Ni (0.21 wt %), Cr (1.1 wt %), Cu (0.04 wt %), Mn (0.76 wt %), Mo (0.19 wt %), Si (0.20 wt %), and Fe (the rest). SUS 630 is able to increase its surface hardness by solution treatment to obtain a strong toughness and have a high hardness.

When the bridge member 5 is made of carburized material such as SCM 415, it is hardened by carburizing hardening to have a surface hardness of about 30˜40 HRC. The caulking portion, guide wall 11, is annealed by an induction tempering apparatus to have a surface hardness of about 15˜23 HRC.

When the surface hardness of the hardened layer, by carburizing hardening, is less than 30 HRC, the impression resistance and wear resistance is insufficient. On the contrary, when the surface hardness exceeds 40 HRC, deformation, due to heat treatment of the bridge member 5, is excessive. When the surface hardness of the guide wall 11, by annealing, is less than 15 HRC, the strength of the caulking portion is, insufficient. On the contrary, when it exceeds 23 HRC, cracks are caused during caulking.

When the bridge member 5 is made of precipitation harden stainless steel such as SUS 630, it is preferable to set the surface hardness at 30 HRC or more, by solution. treatment. SUS 630 has a characteristic feature that its alloy elements can be easily solubilized by heating the material SUS 630 to a predetermined temperature and then by quenching it.

Since the bridge member 5 is made of these carburized materials or sintered material formed of precipitation harden stainless steel by MIM, the connecting groove 5a, where a large stress is caused, has a sufficiently high impression resistance and wear resistance. In addition, since the toughness of the guide wall 11, forming the caulking portion, is also sufficiently high, it is possible to prevent generation of cracks etc. when the bridge member 5 is caulked to the nut 3. Although it is shown as an example where the bridge member 5 is made of a sintered alloy formed by MIM and caulked to the nut 3, the ball screw of the present disclosure is not limited to such an example. Thus, it is possible to use a bridge member made by forging and cutting and adapted to be secured, by adhesion, to the bridge window.

According to the present disclosure, a notch 12 (shown by hatching in FIG. 2(a)) is formed in the bridge member 5. Accordingly, when the bridge member 5 is secured in the bridge window 6, the notch 12 intercommunicates the outer and inner circumferential portions of the nut 3. Thus, it functions as an oil introducing aperture.

In the illustrated embodiment, a circular bridge member 5 and a corresponding circular bridge window 6 are shown. However, other configurations, e.g., an oval bridge member and a corresponding oval bridge window, may be used.

According to the present disclosure, it is unnecessary to specially provide any type of oil introducing aperture in the nut, as in a conventional manner. In addition, it is possible to circulate oil without resistance and without providing any oil discharging aperture even though the ball screw is used in an application where one open end of the nut is blocked.

The ball screw of the present disclosure can be applied to a ball screw used under agitated oil lubrication such as an electric-powered actuator of a vehicle.

The present disclosure has been described with reference to the preferred embodiments. Obviously, modifications and alternations will occur to those of ordinary skill in the art upon reading and understanding the preceding detailed description. It is intended that the present disclosure be construed as including all such alternations and modifications insofar as they come within the scope of the appended claims or their equivalents.

What is claimed is:

1. A ball screw used under agitated oil lubrication comprising:
a screw shaft having a helical screw groove on its outer circumferential surface;
a nut adapted to fit onto the screw shaft, said nut being formed with a helical screw groove on its inner circumferential surface;
a plurality of balls contained in a rolling passage formed by oppositely arranged screw grooves;
a bridge member adapted to fit into a bridge window formed through a barrel wall of the nut, said bridge member having a connecting groove for enabling said balls to bypass the rolling passage to move into a radially outward circumferential passage; and
a notch formed in the bridge member, said notch intercommunicate the outer and inner circumferential portions of the nut.

2. The ball screw according to claim 1 wherein the bridge member is integrally formed with an arm engaging the screw groove of the nut for positioning the bridge member relative to the nut and with guide walls adapted to be caulked to side edges of the bridge window.

3. The ball screw according to claim 1 wherein the bridge member is made of sintered alloy formed by MIM.

4. The ball screw according to claim 1 wherein the guide wall of the bridge member is plastically deformable and has toughness ensuring strength of the caulked portion, and the surface of the connecting groove is hardened at least at 30 HRC or more by heat treatment.

5. The ball screw according to claim 4 wherein the bridge member is made of carburized steel and its surface is hardened by carburizing hardening treatment, and the surface hardness of the guide wall is set at a range of about 15˜23 HRC by annealing.
